(19) United States
(12) Patent Application Publication
(10) Pub. No.: US 2026/0227497 A1
(43) Pub. Date: Aug. 6, 2026

(54) METHOD AND SYSTEM FOR DETERMINING A POSITION OF A PLURALITY OF LIDAR SENSORS FOR INDUSTRIAL RISKY ZONES

(71) Applicant: Siemens Industry Software Ltd., Tel Aviv (IL)

(72) Inventor: Moshe Hazan, Elad (IL)

(21) Appl. No.: 19/150,548

(22) PCT Filed: Feb. 9, 2023
(86) PCT No.: PCT/IB2023/051169

§ 371 Date: Jul. 24, 2025

(51) Int. Cl. G01S 7/497; G01S 13/91

(52) U.S. Cl. CPC G01S 7/497; G01S 13/91

(57) ABSTRACT

A data processing system and a method for determining a position of a plurality of Lidar sensors, reliably detect a risky zone crossing in an industrial environment. The system receives data regarding geometry of the risky zone, a set of moving objects and a set of fixed objects within the zone. The system receives data regarding a total swept volume combining all swept volumes of all motion operations of all moving objects of a cell. The system creates a set of zone slices including zone boundary slices and the set of obstacle shapes and determines a position of a set of configured sensors on the boundary slice, for detecting any crossing of the risky zone slice by a mobile entity larger than a minimal detectable size by at least one configured sensor, even by taking into account the combined detection blockage effects of the set of obstacle shape slices.

### TECHNICAL FIELD

The present disclosure is directed, in general, to computer-aided design, visualization, and manufacturing (“CAD”) systems, product lifecycle management (“PLM”) systems, product data management (“PDM”) systems, production environment simulation, and similar systems, that manage data for products and other items (collectively, “Product Data Management” systems or PDM systems). These systems may include components that facilitate the design and simulated testing of product structures and product manufacture.

### BACKGROUND OF THE DISCLOSURE

In industrial manufacturing, many facilities are often densely “populated” for example by several robots, by other pieces of equipment and by moving or mobile entities e.g. like humans or AGV vehicles. The hazards for mobile entities and for equipment is a well-known critical issue. In order to prevent such hazards, the typical traditional solution consists in erecting safety fences around the risky zones of industrial facilities.

Modern industry is trying to remove the need of such safety fences for example by employing smaller and slower robots or by using new technological means for the big and powerful robots.

For example, light-detection and ranging (“Lidar or LiDAR”) sensors can be employed for safety coverage so that traditional fences can be removed. Lidar sensors positioned along risky zone boundaries can be used to detect the passage of a mobile entity across such risky zones and activate correspondent emergency actions e.g. such signaling, ringing alarms, generating emergency stop signal, robot stopping etc.

However, risky zones usually contain moving and fixed industrial objects which may block the detection coverage of the Lidar sensors. Therefore, unfortunately, current known techniques do not provide industrial workers with reliable and optimal solutions for determining where to position the Lidar sensors on the risky zone boundary for Lidar-based safety setups.

Improved techniques for determining the positions of Lidar sensors for reliably detecting risky zone crossings in industrial environments are desirable.

### SUMMARY OF THE DISCLOSURE

Various disclosed embodiments include methods, systems, and computer readable mediums for determining a position of a plurality of Lidar sensors for reliably detecting a crossing of a risky zone in an industrial environment; wherein the risky zone comprises a set of moving objects and a set of fixed objects and wherein a crossing of the risky zone by a mobile entity has to be detected by at least one Lidar sensor. A method includes receiving data on the geometry of the risky zone on whose boundary the plurality of sensors are to be positioned, data on the set of moving objects within the zone and data on the set of fixed objects within the zone. The method further includes receiving data on a total swept volume combining all swept volumes of all motion operations of all moving objects of the cell. The method further includes receiving data on a minimal size of a mobile entity whose crossing of the zone is to be detected; hereinafter minimal detectable size. The method further includes receiving or determining data for configuring the plurality of Lidar sensors. The method further includes determining a set of zone obstacle shapes as the superimposition of the total swept volume shape and of the fixed object set shape; whereby a zone obstacle located between a given sensor and a given entity portion has the effect of blocking the sensor detection of said entity portion. The method further includes creating a set of zone sections or slices comprising sections or slices of the zone boundary and of the set of obstacle shapes. The method further includes, determining, for each zone slice, a position of a set of configured sensors on the boundary slice so that any crossing of the risky zone slice by a mobile entity larger than the minimal detectable size is detectable by at least one configured sensor even by taking into account the combined detection blockage effects of the set of obstacles shape slices.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented.

FIG. 2 schematically illustrates a flowchart for determining a position of a plurality of Lidar sensors for reliably detecting a crossing of a risky zone in an industrial environment in accordance with disclosed embodiments.

FIG. 3 is a drawing schematically illustrating an example of industrial risky zone.

FIG. 4 is a drawing schematically illustrating an example of industrial risky zone coverable via Lidar sensors in accordance with disclosed embodiments.

FIG. 5 is a drawing schematically illustrating an example of risky zone slicing in accordance with disclosed embodiments.

FIG. 6 is a drawing schematically illustrating an exemplary embodiment of a two-dimensional (“2D”) slice of a risky zone model.

FIG. 7 is a drawing schematically illustrating an exemplary embodiment of inputs and outputs of a module for determining a position of a plurality of Lidar sensor for industrial risky zone.

FIG. 8 is a drawing schematically illustrating exemplary embodiments of slices for Machine Learning (“ML”) training dataset.

FIG. 9 is a drawing schematically illustrating an exemplary embodiments of genetic algorithm usage for determining the Lidar sensors position.

### DETAILED DESCRIPTION

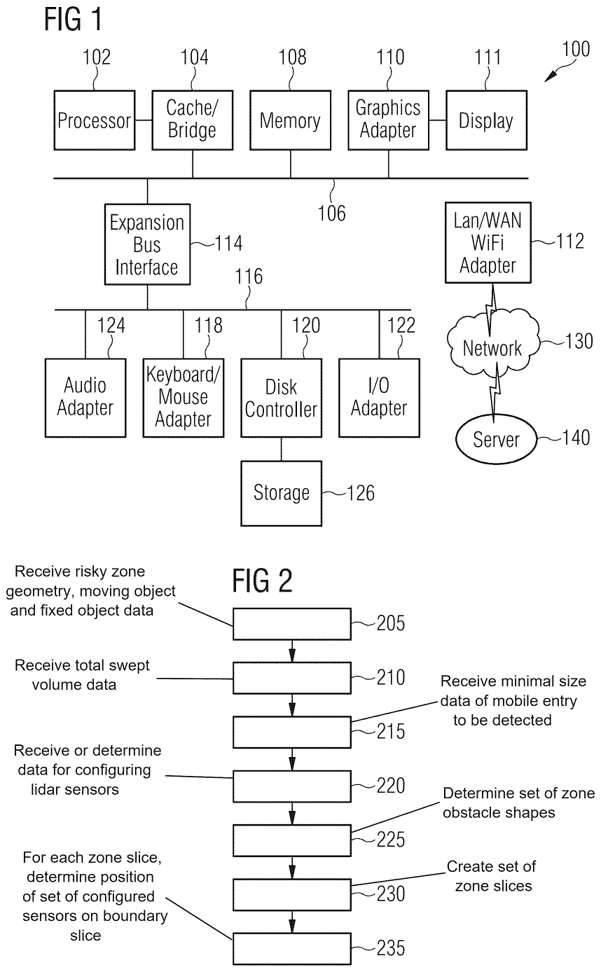

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Previous techniques do not enable to determine a position of a plurality of Lidar sensors for risky zones in optimal and efficient manners. For example, previous techniques are based on manual/not-automatic positioning, on trial and errors and require too much time and effort.

The embodiments disclosed herein provide numerous technical benefits, including but not limited to the following examples.

Embodiments enable to compute the quantity of needed Lidar sensors for covering an industrial risky zone.

Embodiments enable to determine where to place each Lidar sensors in order to get full safety coverage of a risky zone to prevent hazards on human life or equipment.

Embodiments enable to determine where to place each Lidar sensors in automatic and efficient manner.

Embodiments are based on the real robotic tasks performed by robots operating within the risky zone.

Embodiments ensure a safe and optimal coverage by Lidar sensors of a working station.

Embodiments are based on swept volumes and, therefore, the found solutions are independent from time.

Embodiments enable to digitally plan and validate Lidar based safety setups for working stations.

FIG. 1 illustrates a block diagram of a data processing system 100 in which an embodiment can be implemented, for example as a PDM system particularly configured by software or otherwise to perform the processes as described herein, and in particular as each one of a plurality of interconnected and communicating systems as described herein. The data processing system 100 illustrated can include a processor 102 connected to a level two cache/bridge 104, which is connected in turn to a local system bus 106. Local system bus 106 may be, for example, a peripheral component interconnect (PCI) architecture bus. Also connected to local system bus in the illustrated example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but are not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware illustrated in FIG. 1 may vary for particular implementations. For example, other peripheral devices, such as an optical disk drive and the like, also may be used in addition or in place of the hardware illustrated. The illustrated example is provided for the purpose of explanation only and is not meant to imply architectural limitations with respect to the present disclosure.

A data processing system in accordance with an embodiment of the present disclosure can include an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

FIG. 2 illustrates a flowchart for determining a position of a plurality of Lidar sensors for reliably detecting a crossing of a risky zone in an industrial environment in accordance with disclosed embodiments. Such method can be performed, for example, by system 100 of FIG. 1 described above, but the “system” in the process below can be any apparatus configured to perform a process as described.

The risky zone comprises a set of moving objects and a set of fixed objects. The crossing of the risky zone by a mobile entity has to be detected by at least one Lidar sensor.

At act 205, it is received data on the geometry of the risky zone on whose boundary the plurality of sensors are to be positioned, data on the set of moving objects within the zone and data on the set of fixed objects within the zone.

At act 210, it is received data on a total swept volume combining all swept volumes of all motion operations of all moving objects of the cell. In embodiments, the total swept volume is generated departing from data of motion operations of the moving object set via a virtual simulation system. Examples of virtual simulation system include, but are not limited to, Computer Assisted Robotic tools, Process Simulate (a product of Siemens PLM software suite), robotic simulations tool, and other system for industrial simulation. For example, a CAR tool generates the total swept volume within a risky robotic zone by simulating all the received robotic operations of all the operating robots.

At act 215, it is received data on a minimal size of a mobile entity whose crossing of the zone is to be detected; hereinafter minimal detectable size. Examples of mobile entities include but are not limited by a human or an AGV vehicle. Examples of minimal detectable size may be the size of a human hand or the size of a head.

At act 220, it is received or determined data for configuring the plurality of Lidar sensors.

At act 225, it is determined a set of zone obstacle shapes as the superimposition of the total swept volume shape and of the fixed object set shape. A zone obstacle located between a given Lidar sensor and a given entity portion has the effect of blocking the sensor detection of said entity portion.

At act 230, it is created a set of zone slices comprising slices of the zone boundary and of the set of obstacle shapes.

At act 235, for each zone slice, determining a position of a set of configured sensors on the boundary slice so that any crossing of the risky zone slice by a mobile entity larger than the minimal detectable size is detectable by at least one configured sensor even when taking into account the combined detection blockage effects of the set of obstacles shape slices.

In embodiments, the sensors position is determined via optimization algorithms. As the skilled person easily appreciates, the choice of the optimization and of the type of algorithm depend on the given and received parameters and on the variables to be determined and/or optimized. For example, in embodiments, the number of sensors and their configuration is given and the optimization then consists in finding the optimal position of the sensors for which the zone-crossing detection of a minimal size entity is guaranteed. In other embodiments, the number of sensors or the sensors configurations are to be determined and the optimization then consists in finding the optimal number, position, configuration of the sensors for which the zone-crossing detection of a minimal size entity is guaranteed.

In embodiments, the sensor set position may be determined by applying a ML trained module. The input of the ML trained module comprises at least data on the zone boundary slice, data on the obstacle shape set, data on minimal detectable size. The output of the training module comprises at least the position of the set of configured sensors. In embodiments, the ML trained module is trained with input training dataset comprising at least data on the zone boundary slice, data on the obstacle shapes slices and output training dataset comprises at least the position of the configured sensor set on the zone boundary. In embodiments, the obstacles shapes slices for the training dataset may comprise randomly defined shapes.

In embodiments, the sensor set position may be determined by applying a genetic algorithm.

In embodiments, the number of sensors is received or predefined. In other embodiments, the number of sensors is to be determined. In embodiments, in case the step of determining the sensor set position returns no valid outcome, fine tunings may be applied by increasing the number of sensors and/or by changing the sensor configuration data.

In embodiments, the terms “received/receive/receiving”, as used herein, can include retrieving from storage, receiving from another device or process, receiving via an interaction with a user or otherwise.

### Algorithms of Exemplary Embodiments

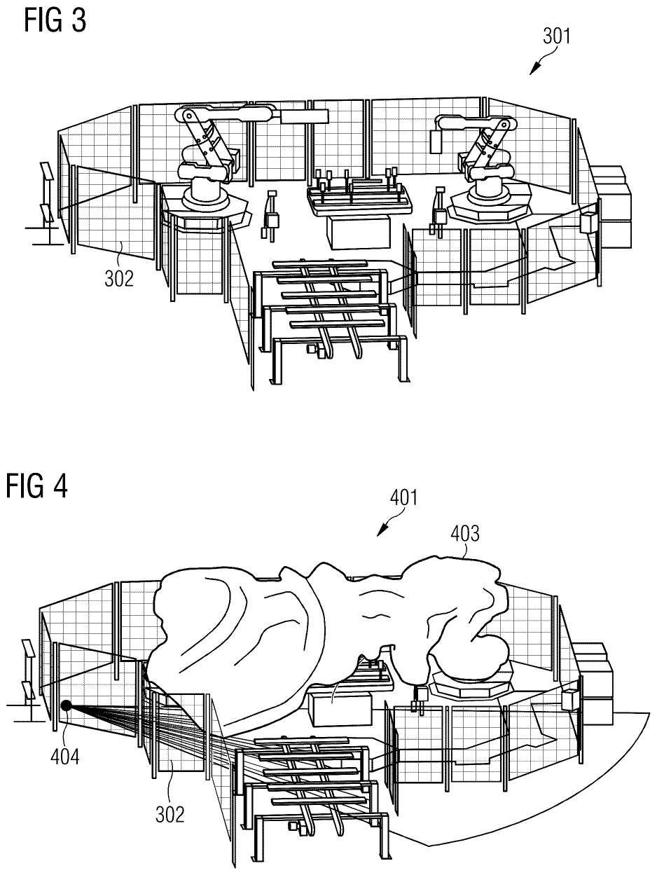

In exemplary embodiments, the main algorithm phases and steps for determining a position of a plurality of Lidar sensors for reliably detecting a crossing of a risky zone in an industrial environment are illustrated below with the help of FIGS. 3 to 9.

FIG. 3 is a drawing schematically illustrating an example of an industrial risky zone 301. The boundary 302 of the risky zone 301 is delimited by a fence. The risky zone 301 comprises two robots and other equipments, devices or objects whereby some industrial objects are moving and whereby some other industrial objects are not moving and therefore are at fixed positions. The depicted fence on the zone boundary 302 is hereinafter pictured for illustration purposes and therefore is to be intended as the boundary of the risky zone and not as a physical fence blocking the crossings to mobile entities. Therefore, the zone boundary 302 can be seen as an “invisible Lidar safety fence” and not a physical fence. This zone boundary 302 delimits the risky zone 301. The Lidar sensors (not shown) are to be positioned on the zone boundary 302. For example, the sensors can be placed on the floor or mounted on poles, posts and/or tripods at different heights so that the zone boundary is conveniently not delimited by a physical fence but rather by a partially invisible zone boundary 302 which is sensor covered. Whenever a mobile entity like human personnel or an AGV vehicle is crossing this boundary 302 the Lidar sensor (not shown) shall be able to detect such a crossing so that a Lidar based safety station can be planned in an industrial facility.

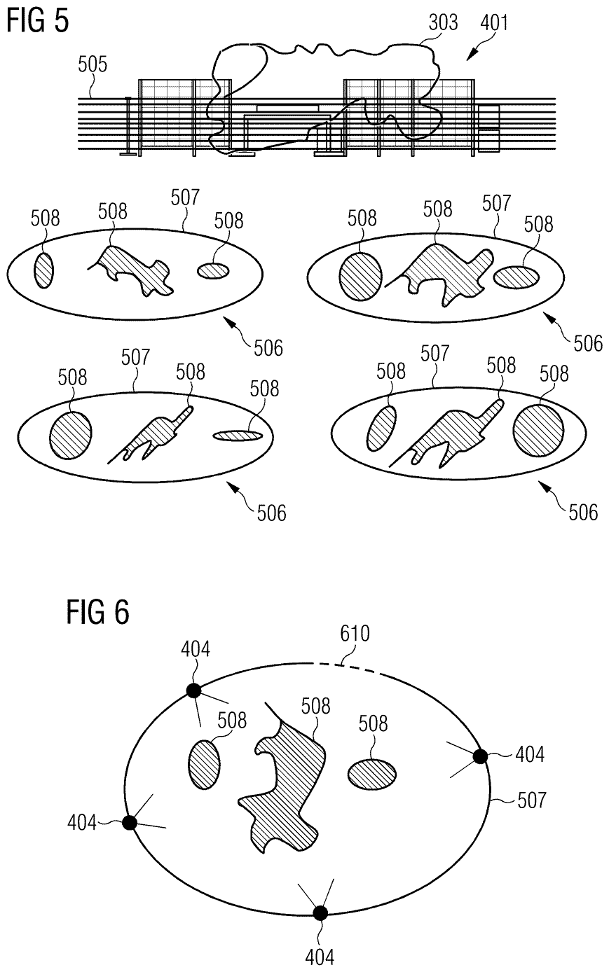

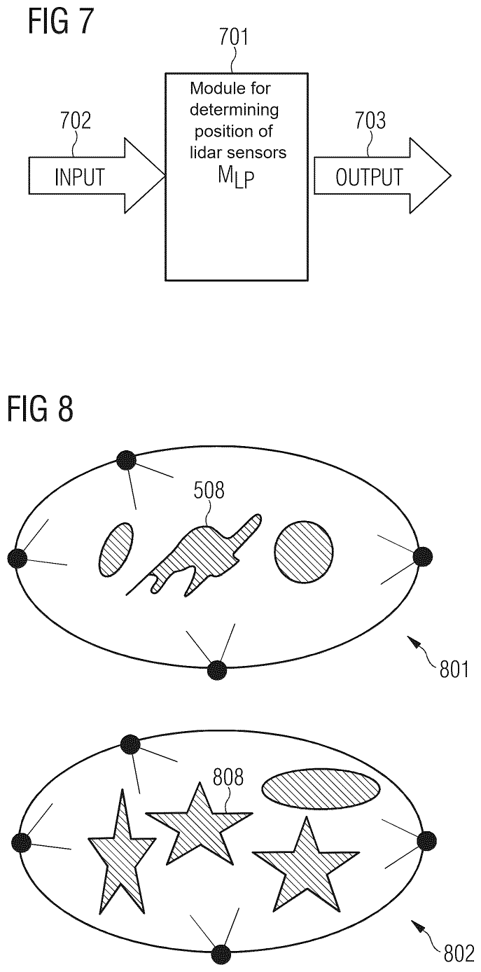

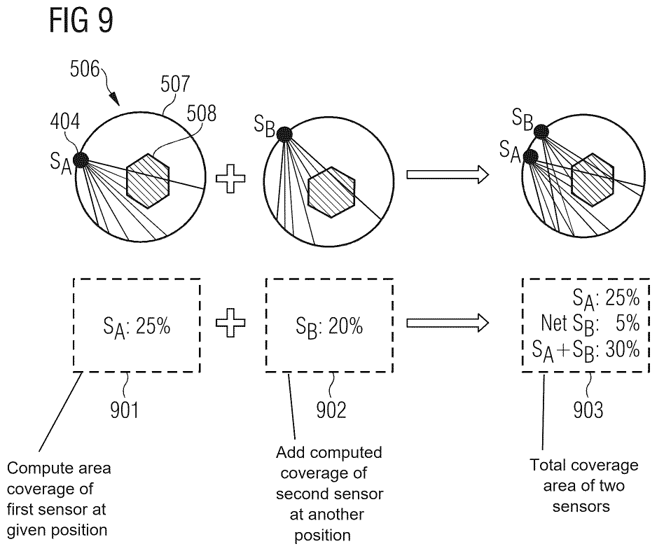

Algorithm embodiments may include on or more of the following main phases:
i) loading the virtual study on the CAR tool;
ii) for each robotic operation, creating the swept volume (SV);
iii) creating a set of Lidar sensors;
iv) combining the virtual representations of the study, of the swept volume, of the Lidar sensors in a combined three-dimensional (“3D”) model where fixed objects and swept volume are superimposed (see FIG. 4);
v) creating a set of sections of «2D slices» comprising zone to cover, sensors, slices of swept volumes+equipments (see FIGS. 5 and 6);
vi) applying an algorithm (see FIG. 7) to determine the Lidar positions based on the above data and on received minimal detectable size of a detectable mobile entity. The lidar positioning algorithm module may be based on ML algorithms (see ML training data type examples of FIG. 8) and/or genetic algorithms (see FIG. 9).

In the first phase i), the data received of virtual study is loaded on the CAR tool. For example, the virtual study comprises a virtual description of the risky zone 302 as shown in FIG. 3. The risky zone comprises moving objects like robots and fixed equipment objects like a table base. The virtual study comprises a virtual description of the geometry of the risky zone boundary 302.

In the second phase ii), for each robotic operation of each robot, the total swept volume is generated. In embodiments, the swept volume is generated by the CAR tool by taking into account all robotic operations of the robots and by taking into account all the swept volumes of other moving industrial objects and devices. In other embodiments, the total swept volume may be retrieved from storage or received from an external source without the need of a CAR tool for generating it.

In the third phase iii), a set of N Lidar sensors is created according to received configuration data and their position is yet to be determined along the boundary of the risky zone. In embodiments, the number N of sensors is received from storage or via an interaction with user or otherwise. In other embodiments, the sensor number N is to be computed via the algorithm. Examples of Lidar configuration data include, but are not limited by, detection range, coverage sector in degrees, number of rays or angles between rays and other Lidar parameters.

In the fourth phase iv), a combined 3D virtual representation 401 is generated by combining the virtual data received or generated during the previous phases i)-iv) as schematically exemplified in the drawing of FIG. 4. FIG. 4 is a drawing schematically illustrating the industrial risky zone 401 with swept volume and a Lidar sensor in accordance with exemplary embodiments. The swept volume 403 of the two robots can be generated within the CAR tool by taking into account the motion volumes of the two robots with all possible robotic operations of the robotic cell. Examples of robotic operations include, but is not limited by, welding, drilling, lasering, cutting, coating, cleaning, picking, measuring and other operations. In exemplary embodiments, data describing robotic operation may comprise robotic targets e.g. <cartesian+robotic configuration> or <joint values>; commands to be performed on those robotic targets; whereby the data may be provided in form of a text file or in form of 3D virtual objects comprising such data. In FIG. 4, one exemplary Lidar sensor 404 is depicted with a black circle and a sector of a set of beam arrays departing from it. The robotic swept volume 403 or the fixed objects 405 acts as obstacles by blocking the detection reach of the sensor beam, thus reducing the area covered by the sensor.

In the fifth phase v), the combined 3D virtual representation is sliced 505 into a set of section slices 506. In the illustrated embodiments the slices 506 have a 2D shape, in other embodiments (not shown) they may have a 3D shape. FIG. 5 schematically illustrates 2D slices 506 with obstacles 508 taken from the combined 3D model 401 of the risky zone. On the upper part of FIG. 5, it is depicted a front view of the risky zone combined model 401 whereby the horizontal lines 505 illustrate a representation of the slices 506 taken at different heights on the combined 3D model 401 where also the swept volume 303 is depicted. In embodiments, the Lidar position problem is solved as a mathematical optimization problem departing from the 3D zone model via section slicing into 2D or into 3D section or slices.

On the below part of FIG. 5, four sketches of different 2D slices 506 are shown for illustration purposes. Each slice 506 include a zone boundary line 507 and three obstacles 508 which—in each slice—present different shapes depending on the heights at which the slice cuts 505 are made. For example, slice cuts may be made departing at a height of 20 cm and repeating each cut every 15 cm until the height of 140 cm is reached. It is noted that the four slices 506 are pictorial representations for illustration purposes only and do not directly correspond to the shapes of the zone 3D model 401 of FIG. 4. For example, the boundary line 507 has an elliptic shape even when the boundary 302 in FIG. 4 has a polygonal shape and the boundary shape 507 of each slice may change depending on the height where the cut is made. Similarly, the obstacle slices 508 are pictorial representations for illustration purposes of the fixed objects slices or from the swept volume slices without direct correspondence to the swept volume and the fixed objects of the 3D models of FIG. 4. The obstacles 508 are filled with a dashed pattern and block the sensor detection of the beam of a Lidar sensor 404.

In the sixth phase vi), an algorithm for determining the optimal position of the set of Lidar sensors is applied. FIG. 6 is a drawing schematically illustrating a risky zone slice/section comprising Lidar sensors and obstacle slices. The N Lidar sensors 404 are positioned along the zone boundary 507 at positions yet to be determined in a way that a crossing of a mobile entity (not shown) of minimal size is detectable by at least one beam of one Lidar sensor 404.

In embodiments, users may conveniently be enabled to provide inputs and exclude selected portions of the zone boundary where sensors cannot be placed for example reflecting areas of the station where, preferably, equipments shall not be placed. In such case, the algorithm is enabled to compute the sensors positions on the zone boundary outside the excluded boundary portions and provides corresponding outcome positions. An example of excluded zone portion 610 is shown with a dashed line. Therefore, in the pictorial embodiment representation of FIG. 6, the zone boundary 507 where the Lidar sensors can be applied is the continuous line of 507 with the exclusion of the dashed line portion 610.

Examples of algorithms that can be applied to optimize the position of the Lidar sensors include, but are not limited to, Machine Learning algorithms e.g. reinforcement learning, genetic algorithms, other optimization algorithms and a combination thereof.

FIG. 7 schematically illustrates the input/output of a module 701 for determining a position of a plurality of Lidar sensors in accordance with disclosed embodiments.

The module M_{LP} 701 determines at least the positions of each Lidar sensor provided as output data 703. In embodiments, the position of a Lidar sensor may be defined by position and orientation coordinates (X, Y, Z, RX, RY, RZ). In embodiments, the input data 702 of the Lidar positioning module 701 may comprise one or more of the following data: 2D geometry of the risky zone area 507; 2D shapes of the obstacles 508 per relevant height of the slice cut; configuration data for the Lidar sensors 404 (e.g. coverage sector in degrees or radians, number of rays or angles between rays); number N of Lidar sensors, minimal detectable size of a mobile entity. In embodiments, the algorithm performed by the LiDAR position module 701 computes output data 703 based on received input data 702 and based on an heuristic approach by ignoring uncovered areas smaller than predefined sizes. In embodiments, with the heuristic approach, the algorithm considers “uncovered” areas that are too small to be entered by a human or any other mobile entity as if those small areas are “covered” so that full coverage is achieved. In embodiments, small fractions of not covered areas whereby a mobile entity of minimal detectable size cannot enter are heuristically considered by the algorithm as if full sensor coverage were achieved.

In embodiments, the input data 702 of the lidar position computation module 701 comprise the number N of Lidar sensors. In other embodiments, the sensor number N is computed by the module 701 and therefore is comprised in the output data 703 and not in the input data 702. In summary, the number of sensors N may be part of the input data 702—e.g. the user asks the lidar position module 701 where to position the N Lidar sensors—or the sensor number N is part of the output data 703—e.g. the user asks how many sensors shall be utilized and where shall they be positioned.

As the skilled person easily appreciates, in embodiments, the zone slices may have a 2D or 3D shape depending on the format of the heights of the slice cuts.

In embodiments, where the heights for cutting a slice 505 are in number format (e.g. 45 cm), the resulting slices 506 have 2D shapes and the optimization algorithm solves a 2D problem. In other embodiments, where the height for cutting a slice (not shown) are in numerical range/interval format (e.g. 44-46 cm), the resulting slices 506 have a 3D shape so that the optimization algorithm solves a 3D problem.

In embodiments, input data 702 comprise a virtual study, Lidar configuration. In embodiments, the output data 703 comprise Lidar positions for safety coverage whereby obstacles from swept volumes for each moving objects and from fixed objects are taken into account.

### Exemplary Embodiment of a ML Algorithm

In an exemplary embodiment, the module M_{LP} for Lidar positioning comprises steps to solve a ML algorithm, e.g. a reinforcement learning problem. For example, assume that the number N of Lidar sensors is to be determined, the states may consist in changing the number of Lidar and their positions and the reward function consists in higher scores for larger covered areas and for smaller numbers of sensors (optional). Heuristically, in embodiments, small fractions of not covered areas that humans cannot physically enter can be considered as if those areas were fully covered.

In embodiments, the training data set for training the ML algorithm may be collected from real case scenarios or they may be synthetically generated—with or without using a simulation system. FIG. 8 is a drawing schematically illustrating exemplary slices for ML training dataset in accordance with disclosed embodiments. The upper zone slice 801 is an example of slice where the obstacles 508 are generated by slicing a 3D model of a risky zone with swept volume. The bottom zone slice 802 is an example of slice where the obstacles 808 are fake obstacles synthetically generated for example according to various criteria which can be user defined or learned from collected data of historical facility cells.

In a first exemplary embodiment of synthetic data generation, the main training data generations phases include one or more of the steps of: using several virtual robots; defining a position for each robot; for each robot, generating some random tasks (e.g. locations); playing simulation and generating the swept volume; slicing the swept volume to a plurality of 2D slices 801; export each SV slice 801 to a different test case; for each test case, defining sensors data plus area to cover and running the algorithm and collecting the output dataset as training data for the Artificial Intelligence (AI) algorithm modeling the Lidar position module 701.

In a second exemplary embodiment of synthetic data generation, it includes the steps of generating a “fake” list of 2D drawing slices 802 with fake obstacles 808, and such slices 802 are used as training dataset to train the AI algorithm. Advantageously, there is no need of using a simulation and/or defining virtual robot(s). Advantageously this second exemplary embodiment may be a faster way to generate the training data set for the AI algorithm model for the Lidar position module 701.

### Exemplary Embodiment of a Genetic Algorithm

In an exemplary embodiment, the module for Lidar positioning M_{LP} comprises steps to solve a genetic algorithm problem. In embodiments, the sequence or chain of items, the gonium, is the list of Lidar sensors of a single solution. In embodiments, according to a first technique, each item—a Lidar sensor—is evaluated by how net coverage it adds to the coverage of the previous sensors. In embodiments, according to a second technique, each solution, a sequence of Lidar sensors, is evaluated by how much total coverage it achieves. Embodiments may include a combination of the first and the second technique.

FIG. 9 is a drawing schematically illustrating an exemplary of genetic algorithm usage for determining the Lidar sensors position in accordance with disclosed embodiments. A representation of a 2D slices of risky zones 506 comprise Lidar sensors 404, obstacles 508 as previously described. The sensors SA, SB 404 have coverage sectors (in degrees or radians) whose detection areas is blocked by the obstacle 508.

For example, assume that, for a first sensor SA at a given position (X, Y, Z, RX, RY, RY), its coverage area is computed 901 and results of being 25% of the total risky area to be covered. Adding 902 a second sensor S_{B} at another position with computed coverage 20%, it brings in an additional net coverage of 5% (=25%−20%). The total coverage area 903 of the two sensors S_{A}, S_{B} 404 is therefore 30% (25%+5%). For example, assume that there is a third sensor S_{C} (not shown), the value of the first sensor S_{A} is its coverage area, the value of the second sensor is S_{B} is its coverage area, minus the area covered by the previous sensor S_{A}, the value of the third sensor is S_{C} is its coverage area minus the coverage area of the combination of sensors S_{A} and S_{B}. In this manner, the gonium of the sensors with larger coverage is passed to the next generation, also with some mutations in order not to provide a solution that is more global and not too local. At each iteration, the genetic algorithm keeps trying and evaluating different positions of the sensors. The algorithm starts with N number of sensors and try to reach a full zone coverage. In embodiments, if no solution is found, the number of sensors is increased to N+1 and the algorithm tries again until full coverage is reached. Heuristically, in embodiments, small fractions of not covered areas that humans cannot physically enter can be considered as if those areas were fully covered. In embodiments, unlike in the case of the reinforcement learning algorithm where the provide solution can be seen as a single holistic solution, with the genetic algorithm, each sensor or sensor sequence or a combination thereof is evaluated separately. In fact, typically in the reinforcement learning algorithm the order of the sensor sequence has typically no influence or value, with the genetic algorithm, the order plays an important to evaluate what is the value of adding each additional sensor of top the other existing Lidar sensors.

In summary, Table 1 below provides a high-level comparison of the features of the AI-based approach versus the genetic algorithm approach for computing the position of the Lidar sensors in accordance with embodiments.

TABLE 1
high-level comparison the AI-based
algorithm vs the genetic algorithm

| | AI-based approach | Genetic approach |
|---|---|---|
| Training | Needed | Not needed |
| (dataset, time | | |
| effort) | | |
| Speed | Fast | It takes time |
| Accuracy | It depends on the training | Accurate |
| | dataset | |
| Outcome | Same result | Different results |
| Point of view | All the sensors are seen as a | Each sensor is evaluated |
| | single holistic solution | separately |

Examples of algorithms of the module 701 includes but are not limited by AI/ML algorithms, genetic algorithms or any other algorithm which given the input data 702 solves and optimizes the output solution 703 via an heuristic approach for small uncovered areas. In embodiments, the module 702 may comprise a set of submodules which may also run a plurality of algorithms for example, in parallel, by collecting the results, by analyzing them all and by returning a pool of optimal chosen solutions 703. In embodiments, the module 702 can start by applying the ML algorithm and use its outcome result as a use case of the genetic algorithm i.e. the genetic algorithm considers the ML algorithm outcome as one of the leading options and tries to find a better one.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being illustrated or described herein. Instead, only so much of a data processing system as is unique to the present disclosure or necessary for an understanding of the present disclosure is illustrated and described. The remainder of the construction and operation of data processing system 100 may conform to any of the various current implementations and practices known in the art.

It is important to note that while the disclosure includes a description in the context of a fully functional system, those skilled in the art will appreciate that at least portions of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims.

1-20. (canceled)

21. A method for determining, by a data processing system, a position of a plurality of Lidar sensors for reliably detecting a crossing of a risky zone in an industrial environment, the risky zone including a set of moving objects and a set of fixed objects, and at least one Lidar sensor configured to detect a crossing of the risky zone by a mobile entity, the method comprising:
a) receiving data regarding a geometry of the risky zone having a boundary at which the plurality of sensors are to be positioned, data regarding the set of moving objects within the zone and data regarding the set of fixed objects within the zone;
b) receiving data regarding a total swept volume combining all swept volumes of all motion operations of all moving objects of a cell;
c) receiving data regarding a minimal detectable size of a mobile entity, for detecting crossing of the zone by the mobile entity;
d) receiving or determining data for configuring the plurality of Lidar sensors;
e) determining a set of zone obstacle shapes as a superimposition of the total swept volume shape and of the fixed object set shape, a zone obstacle located between a given sensor and a given entity portion having an effect of blocking sensor detection of the entity portion;
f) creating a set of zone slices including slices of the zone boundary and of the set of obstacle shapes; and
g) for each zone slice, determining a position of a set of configured sensors on the boundary slice for detecting any crossing of the risky zone slice by a mobile entity larger than the minimal detectable size by at least one configured sensor, and taking combined detection blockage effects of the set of obstacle shape slices into account.

22. The method according to claim 21, which further comprises determining a sensor set position by applying a machine learning trained module, the machine learning trained module receiving as an input at least data regarding a zone boundary slice, data regarding the obstacle shape set, and data regarding the minimal detectable size, and the machine learning trained module providing as an output at least the position of the set of configured sensors.

23. The method according to claim 21, which further comprises determining the sensor set position by applying a genetic algorithm.

24. The method according to claim 21, which further comprises receiving or determining a number of sensors.

25. The method according to claim 21, which further comprises generating the total swept volume by departing from data of motion operations of the moving object set via a simulation.

26. The method according to claim 21, which further comprises when determining the sensor set position provides no valid outcome, applying fine tunings by at least one of increasing a number of sensors or changing sensor configuration data.

27. The method according to claim 22, which further comprises training the machine learning trained module with an input training dataset including at least data regarding the zone boundary slice and data regarding obstacle shape slices and an output training dataset including at least the position of the configured sensor set on the zone boundary.

28. The method according to claim 27, which further comprises including randomly defined shapes in the obstacle shape slices for the training dataset.

29. A data processing system, comprising:
a processor; and
an accessible memory;
the data processing system configured to:
a) receive data regarding a geometry of a risky zone having a boundary at which a plurality of sensors are to be positioned, data regarding a set of moving objects within the zone and data regarding a set of fixed objects within the zone;
b) receive data regarding a total swept volume combining all swept volumes of all motion operations of all moving objects of a cell;
c) receive data regarding a minimal detectable size of a mobile entity, for detecting crossing of the zone by the mobile entity;
d) receive or determine data for configuring a plurality of Lidar sensors;
e) determine a set of zone obstacle shapes as a superimposition of a total swept volume shape and of a fixed object set shape, a zone obstacle located between a given sensor and a given entity portion having an effect of blocking sensor detection of the entity portion;
f) create a set of zone slices including slices of the zone boundary and of the set of obstacle shapes; and
g) for each zone slice, determine a position of a set of configured sensors on the boundary slice, causing any crossing of the risky zone slice by a mobile entity larger than the minimal detectable size to be detected by at least one configured sensor, and taking combined detection blockage effects of the set of obstacles shape slices into account.

30. The data processing system according to claim 29, wherein the sensor set position is determined by applying a machine learning trained module, the machine learning trained module receiving as an input at least data regarding the zone boundary slice, data regarding the obstacle shape set, and data regarding the minimal detectable size, and the machine learning trained module providing as an output at least the position of the set of configured sensors.

31. The data processing system according to claim 29, wherein the sensor set position is determined by applying a genetic algorithm.

32. The data processing system according to claim 29, wherein a number of sensors is received or to be determined.

33. The data processing system according to claim 29, wherein the total swept volume is generated by departing from data of motion operations of the moving object set via a simulation.

34. The data processing system according to claim 29, wherein the machine learning trained module is trained with an input training dataset including at least data regarding the zone boundary slice and data regarding obstacle shape slices and an output training dataset including at least the position of the configured sensor set on the zone boundary.

35. A non-transitory computer-readable medium encoded with executable instructions that, when executed, cause at least one data processing system to:
a) receive data regarding a geometry of a risky zone having a boundary at which a plurality of sensors are to be positioned, data regarding a set of moving objects within the zone and data regarding a set of fixed objects within the zone;
b) receive data regarding a total swept volume combining all swept volumes of all motion operations of all moving objects of a cell;
c) receive data regarding a minimal detectable size of a mobile entity, for detecting crossing of the zone by the mobile entity;
d) receive or determine data for configuring a plurality of Lidar sensors;
e) determine a set of zone obstacle shapes as a superimposition of a total swept volume shape and of a fixed object set shape, a zone obstacle located between a given sensor and a given entity portion having an effect of blocking sensor detection of the entity portion;
f) create a set of zone slices including slices of the zone boundary and of the set of obstacle shapes; and
g) for each zone slice, determine a position of a set of configured sensors on the boundary slice, causing any crossing of the risky zone slice by a mobile entity larger than the minimal detectable size to be detected by at least one configured sensor, and taking combined detection blockage effects of the set of obstacles shape slices into account.

36. The non-transitory computer-readable medium according to claim 35, wherein the sensor set position is determined by applying a machine learning trained module, the machine learning trained module receives as an input at least data regarding the zone boundary slice, data regarding the obstacle shape set, and data regarding the minimal detectable size, and the machine learning trained module provides as an output at least the position of the set of configured sensors.

37. The non-transitory computer-readable medium according to claim 35, wherein the sensor set position is determined by applying a genetic algorithm.

38. The non-transitory computer-readable medium according to claim 35, wherein a number of sensors is received or to be determined.

39. The non-transitory computer-readable medium according to claim 35, wherein the total swept volume is generated by departing from data of motion operations of the moving object set via a simulation.

40. The non-transitory computer-readable medium according to claim 35, wherein the machine learning trained module is trained with an input training dataset including at least data regarding the zone boundary slice and data regarding obstacle shape slices and an output training dataset including at least the position of the configured sensor set on the zone boundary.
